(19) United States
(12) Patent Application Publication
(10) Pub. No.: US 2014/0141125 A1
(43) Pub. Date: May 22, 2014

(54) DAIRY PRODUCT CONTAINING FUNCTIONAL ALGINIC ACID BEADS, AND PREPARATION METHOD THEREOF

(71) Applicant: Gye-Hwan Roh, Gyeonggi-do (KR)

(72) Inventor: Gye-Hwan Roh, Gyeonggi-do (KR)

(73) Assignee: PALM DREAM CO., LTD., Gyeonggi-do (KR)

(21) Appl. No.: 13/820,782

(22) PCT Filed: Jul. 12, 2012
(86) PCT No.: PCT/KR2012/005533

§ 371 Date: Mar. 5, 2013

(30) Foreign Application Priority Data
Jul. 14, 2011 (KR) 10-2011-0069987

(51) Int. Cl. A23C 9/20

(52) U.S. Cl. CPC A23C 9/20
USPC 426/72; 426/580

(57) ABSTRACT

Provided are a dairy product containing functional alginic acid beads and a preparation method thereof. The dairy product includes a composition containing 1 to 10% of alginic acid beads based on the weight of the dairy product. The alginic acid beads are formed by dropping into a 1.0 to 5.0% calcium lactate solution, a mixed solution including 0.5 to 15.0% by weight of a functional material including vitamin C, vitamin E, iron, omega-3, a water-soluble dietary fiber or a combination thereof, 25.0 to 45.0% by weight of refined sugar, 0.5 to 2.0% by weight of sodium alginate, 0.001 to 0.1% by weight of a grapefruit seed extract, 0.5 to 1.5% by weight of a natural pigment and 37.0 to 60.0% by weight of purified water. The dairy product contains alginic acid beads containing functional dietary fiber material and functional material in beads visible to the naked eyes to provide nutritional satisfaction and visual satisfaction. The product provides children and the old intaking thereof and young people favoring trendy beverages with balanced nutrients. Particularly, the present invention contributes to the prevention of childhood obesity, promotes consumption of the dairy products to enhance national health and profitability for livestock farms, and maximizes functionality and nutritional properties of the dairy products by fundamentally solving deficiency of the dietary fiber content.

### TECHNICAL FIELD

The present invention relates to a dairy product containing functional alginic acid beads and a preparation method thereof, and more particularly, to a dairy product containing functional alginic acid beads for providing nutritional satisfaction as well as visual satisfaction of consumers at the same time and for resolving shortcomings of the dairy product that lacks dietary fiber by containing functional dietary fiber material-containing alginic acid beads and by including functional material in beads that are visible to the naked eyes, and a preparation method thereof.

### BACKGROUND ART

In general, various types of beverages mixed with beads have been developed and sold. Such beads are prepared by slicing an agar-jellied food into adequate-sized pieces after preparing agar by mixing powder agar, white sugar, starch syrup and water, heating and sterilizing the mixture, cooling the sterilized mixture, injecting anhydrous citric acid, sodium citrate and incense or pigment into the cooled mixture, and uniformly stirring the materials.

Such bead-mixed beverages include beverages having colors and natural fruit juice flavors such as orange, apple, grape and others are widely sold in the market.

However, the functions of the beverages as products with balanced nutrients is hard to be expected since the bead-mixed beverages of the related art focus on the improvement of flavors and drinkability, and since nutritional properties have not been taken into consideration accordingly.

Further, the intake of dairy products has recently been recommended according to an increase in concern over the health. The dairy products have been called as a complete food and have been ingested as a primary nutrition source since such dairy products include liquid milk, fermented milk, concentrated milk, frozen milk, cheese, butter and so on as processed food, and contain relatively uniform nutrients compared to other foodstuffs.

However, such dairy products have had problems that it is not enough for the dairy products to draw attention of the consumers and simply dairy products themselves have limitations in providing more balanced nutrients due to a trend that consumers favor various trendy beverages or concept beverages.

On the other hand, interest in alginic acid bead-containing products as health beverages or food is being increased. For instance, “Alginic acid bead beverage and preparation method thereof” are disclosed in Korean Patent Publication No. 10-2007-0104265, which improves nutritional properties of a bead beverage by adding essential amino acids in beads.

Further, “Preparation method of alginic acid-added health beverage for obesity prevention” is disclosed in Korean Patent Publication No. 10-1995-0026404 as other example, wherein the alginic acid-added health beverage for obesity prevention is prepared by mixing polydextrose which has been extracted from a plant to obtain high solubility with ultra-low viscosity sodium alginate of which viscosity has been minimized by using as raw material alginic acid extracted from marine plants such as seaweed, kelp and others to dissolve the mixture into purified ionic water, fortifying natural Taurine with the dissolved solution, adding propyleneglycol alginate (PGA), potassium carbonate and calcium lactate, citric acid and sodium citrate, and others in the natural Taurine-fortified solution to mix and stir the materials, centrifuging the mixture, and sterilizing the resulting material at high temperatures.

Furthermore, “Jelly beverage containing devil's tongue jelly beads and preparation method thereof” are disclosed in Korean Patent Publication No. 10-2006-0095043, characterized by adding beads prepared with devil's tongue jelly having texture relatively harder than the jelly-textured liquid phase in a jelly-textured liquid phase including a jelly liquid prepared using Gellan gum, Carrageenan or Xanthan gum as a gelling agent such that the jelly beverage containing devil's tongue jelly beads is softer and has more elasticity than jelly beverages of the related art, charging the mixture into a vessel while sufficiently sterilizing and stirring the beads and the jelly-textured liquid phase in a temperature range in which the devil's tongue jelly beads do not stuck to each other, and shaking and cooling the mixture such that the devil's tongue jelly beads are uniformly distributed in the jelly-textured liquid phase.

However, such bead beverages or health beverages have limitations in improvement of health through uniform intake of nutrients since nutrients are added in simple beverages to prepare the bead beverages or health beverages, and the bead beverages or health beverages had problems of having limitations in providing visual satisfaction since qualities such as bead shape and others have not been taken into consideration at all in the preparation of alginic acid beads.

Further, it has been required to develop beverage products of improving processing or preparation characteristics due to difficulties in processing or preparing beverages containing nata de coco, devil's tongue jelly beads, agar beads and others.

### DISCLOSURE

### Technical Problem

In order to solve problems of the related art as described above, the present invention provides nutritional satisfaction as well as visual satisfaction of consumers at the same time to provide children and the old to whom intake of dairy products is recommended and young people favoring trendy beverages with balanced nutrients, and promotes consumption of the dairy products to enhance national health and profitability for livestock farms.

The present invention maximizes functionality and nutritional properties of the dairy products by fundamentally solving deficiency of the dietary fiber content, a demerit of the dairy products. Other objects of the present invention will be easily understood through the description on the following embodiments.

### Technical Solution

In order to achieve the objects described above, a dairy product containing functional alginic acid beads is provided. The dairy product includes a composition containing 1 to 10% of alginic acid beads on the basis of the weight of the dairy product. The alginic acid beads are formed by dropping a mixed solution including 0.5 to 15.0% by weight of a functional material including vitamin C, vitamin E, iron, omega-3, a water-soluble dietary fiber or a combination thereof, 25.0 to 45.0% by weight of refined sugar, 0.5 to 2.0% by weight of sodium alginate, 0.001 to 0.1% by weight of a grapefruit seed extract, 0.5 to 1.5% by weight of natural pigment and 37.0 to 60.0% by weight of purified water into a 1.0 to 5.0% calcium lactate solution, and molding.

The dairy product may include one of milk, fermented milk, ice cream, cheese, and butter.

The alginic acid beads may have a bead size corresponding to 1.0 to 10.0 mm.

According to other aspect of the present invention, provided is a preparation method of a dairy product containing functional alginic acid beads. The method includes preparing alginic acid beads having a bead size corresponding to 1.0 to 10.0 mm by heating a mixed solution including 0.5 to 15.0% by weight of a functional material including vitamin C, vitamin E, iron, omega-3, a water-soluble dietary fiber or a combination thereof, 25.0 to 45.0% by weight of refined sugar, 0.5 to 2.0% by weight of sodium alginate, 0.001 to 0.1% by weight of a grapefruit seed extract, 0.5 to 1.5% by weight of a natural pigment and 37.0 to 60.0% by weight of purified water to a temperature of 85 to 90° C. for 30 to 40 minutes, dropping the heated mixed solution into a 1.0 to 5.0% calcium lactate solution, and molding; sterilizing the alginic acid beads; and mixing the sterilized alginic acid beads with the dairy product in an amount of 1 to 10% by weight of the dairy product.

### Advantageous Effects

In a dairy product containing functional alginic acid beads and a preparation method thereof according to the present invention, the present invention in itself not only contains alginic acid beads containing functional dietary fiber material but also includes functional material in beads that are visible to the naked eyes to provide nutritional satisfaction as well as visual satisfaction of consumers at the same time and provide children and the old to whom intake of dairy products is recommended and young people favoring trendy beverages with balanced nutrients accordingly. In particular, the present invention contributes to the prevention of childhood obesity that has been increased lately, promotes consumption of the dairy products to enhance national health and profitability for livestock farms, and maximizes functionality and nutritional properties of the dairy products by fundamentally solving deficiency of the dietary fiber content that is a demerit of the dairy products.

### DESCRIPTION OF DRAWING

FIG. 1 is a flow chart for describing a preparation method of a dairy product containing functional alginic acid beads according to an embodiment of the present invention.

### BEST MODE

Hereinafter, preferred embodiments of the present invention will be described in detail with reference to accompanying drawing.

Reference will now be made in detail to embodiments, examples of which are illustrated in the accompanying drawing, wherein like reference numerals refer to the like elements throughout. In this regard, the present embodiments may have different forms and should not be construed as being limited to the descriptions set forth herein. Accordingly, the embodiments are merely described below, by referring to the FIGURE, to explain aspects of the present description.

### Mode for Invention

A dairy product containing functional alginic acid beads according to an embodiment of the present invention includes a composition containing 1 to 10% of alginic acid beads with respect to the weight of the dairy product.

The alginic acid beads are formed by dropping a mixed solution including functional material, refined sugar, sodium alginate, grapefruit seed extract, natural pigment and purified water into a calcium lactate solution, and then molding. In embodiments of the present invention, the alginic acid beads are formed by dropping into a 1.0 to 5.0% calcium lactate solution a mixed solution including 0.5 to 15.0% by weight of functional material including all or a portion of vitamin C, vitamin E, iron, omega-3 and water-soluble dietary fiber, 25.0 to 45.0% by weight of refined sugar, 0.5 to 2.0% by weight of sodium alginate, 0.001 to 0.1% by weight of grapefruit seed extract, 0.5 to 1.5% by weight of natural pigment and 37.0 to 60.0% by weight of purified water.

The functional material has been called as a material having a functionality in a sense for supplementing particular nutrients, may include vitamin C, vitamin E, iron, omega-3, water-soluble dietary fiber or a combination thereof as described above, may additionally include material having other nutrients, and may be used in the amount of 0.5 to 15.0% by weight of the mixture such that the functional material may be controlled according to daily recommended allowance of nutrients.

The refined sugar is used in the amount of 25.0 to 45.0% by weight of the mixture to enable Brix to be controlled according to a base of the dairy product applied and allow the dairy product to maintain an appropriate level of Brix.

The sodium alginate is used in the amount of 0.5 to 2.0% by weight of the mixture to satisfy the range required in forming a cross-linkage by cation exchange of two sodium ions and one calcium ion when injecting calcium into a sodium alginate solution.

The grapefruit seed extract is used in the amount of 0.001 to 0.1% by weight of the mixture to exhibit natural preservative and antibacterial effects.

The natural pigment is used in the amount of 0.5 to 1.5% by weight of the mixture to enable chromaticity control.

The purified water is used in the amount of 37.0 to 60.0% by weight of the mixture to enable Brix to be controlled according to a base of the dairy product applied and allow the dairy product to maintain an appropriate level of Brix.

The calcium lactate solution has a concentration of 1.0 to 5.0% to maintain an appropriate calcium concentration.

Further, the alginic acid beads have a bead size corresponding to 1.0 to 10.0 mm. The alginic acid beads have a bead size of 1.0 to 10.0 mm since the alginic acid beads not only lower reliability of the alginic acid beads as a product, but also make it difficult to expect functionality as beads by causing a dairy product to be seen muddy if the alginic acid beads have a bead size of less than 1.0 mm, and the alginic acid beads deteriorate drinkability if the alginic acid beads have a bead size of more than 10 mm.

Examples of dairy products may include milk, fermented milk, ice cream, cheese and butter. However, the dairy products may include various dairy products without being limited to the above-mentioned examples.

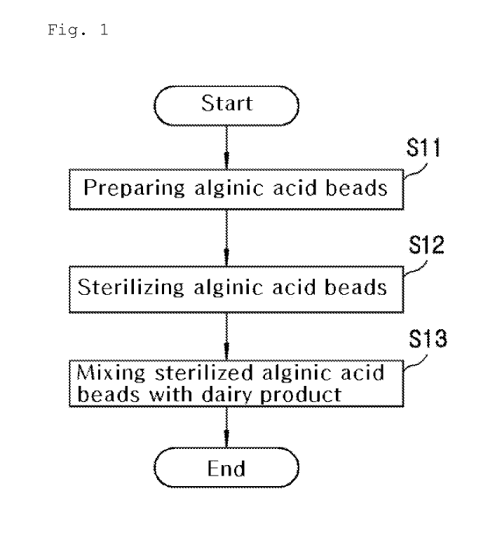

FIG. 1 is a flow chart illustrating a preparation method of a dairy product containing functional alginic acid beads according to an embodiment of the present invention. A preparation method of a dairy product containing functional alginic acid beads according to the present invention may largely include a step S11 of preparing alginic acid beads, a step S12 of sterilizing the alginic acid beads, and a step S13 of mixing the sterilized alginic acid beads into a dairy product.

The step S11 of preparing the alginic acid beads includes heating a mixed solution comprising 0.5 to 15.0% by weight of functional material including a portion or all of vitamin C, vitamin E, iron, omega-3 and water-soluble dietary fiber, 25.0 to 45.0% by weight of refined sugar, 0.5 to 2.0% by weight of sodium alginate, 0.001 to 0.1% by weight of grapefruit seed extract, 0.5 to 1.5% by weight of natural pigment and 37.0 to 60.0% by weight of purified water to a temperature of 85 to 90° C. for 30 to 40 minutes, and dripping the heated mixed solution into a 1.0 to 5.0% calcium lactate solution to prepare alginic acid beads having a bead size corresponding to 1.0 to 10.0 mm. The mixed solution is heated to the temperature of 85 to 90° C. for 30 to 40 minutes to optimize loss prevention of nutrients while enabling the mixture comprising the above-mentioned materials to form desired alginic acid beads when dripping the mixture into the calcium lactate solution to form the alginic acid beads. On the other hand, alginic acid is material having a wide range of application as a hydrophilic colloidal anionic polysaccharide found on cell walls of Laminaria brown algae and seaweeds, and alginic acid beads may be prepared using the principle of forming a cross-linkage by cation exchange of two sodium ions and one calcium ion when injecting calcium into a sodium alginate solution.

The step S12 of sterilizing the alginic acid beads is a step of sterilizing the alginic acid beads that have been formed by dripping the heated mixed solution into the calcium lactate solution, wherein, for instance, the alginic acid beads may be sterilized by a heat treatment process performed at a temperature of 120 to 130° C. for about 1 to 10 seconds.

The step S13 of mixing the sterilized alginic acid beads into the dairy product may be conducted during the process of preparing the dairy product according to properties of a dairy product such as milk, fermented milk, ice cream, cheese, or butter as a step of mixing the sterilized alginic acid beads with the dairy product in the amount of 1 to 10% by weight of the dairy product.

As described above, in a dairy product containing functional alginic acid beads and a preparation method thereof according to the present invention, the present invention in itself not only contains alginic acid beads containing functional dietary fiber material but also includes functional material in beads that are visible to the naked eye to provide nutritional satisfaction as well as visual satisfaction of consumers at the same time, provide children and the old to whom intake of dairy products is recommended and young people favoring trendy beverages with balanced nutrients accordingly, and particularly contribute to the prevention of childhood obesity that has been increased lately.

Further, the present invention promotes consumption of the dairy products to enhance national health and profitability for livestock farms, and fundamentally solves deficiency of the dietary fiber content that is a demerit of the dairy products by containing dietary fiber material in the alginic acid beads to maximize functionality and nutritional properties of the dairy products accordingly.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A dairy product containing functional alginic acid beads, comprising a composition containing 1 to 10% of alginic acid beads on the basis of a weight of the dairy product,
the alginic acid beads being formed by dropping a mixed solution comprising 0.5 to 15.0% by weight of a functional material including vitamin C, vitamin E, iron, omega-3, a water-soluble dietary fiber or a combination thereof, 25.0 to 45.0% by weight of refined sugar, 0.5 to 2.0% by weight of sodium alginate, 0.001 to 0.1% by weight of a grapefruit seed extract, 0.5 to 1.5% by weight of a natural pigment and 37.0 to 60.0% by weight of purified water, into a 1.0 to 5.0% calcium lactate solution, and molding.

2. The dairy product containing functional alginic acid beads of claim 1, wherein the dairy product includes one of milk, fermented milk, ice cream, cheese, and butter.

3. The dairy product containing functional alginic acid beads of claim 1, wherein the alginic acid beads have a bead size corresponding to 1.0 to 10.0 mm.

4. A preparation method of a dairy product containing functional alginic acid beads, comprising:
preparing alginic acid beads having a bead size corresponding to 1.0 to 10.0 mm by heating a mixed solution comprising 0.5 to 15.0% by weight of a functional material including vitamin C, vitamin E, iron, omega-3, a water-soluble dietary fiber or a combination thereof, 25.0 to 45.0% by weight of refined sugar, 0.5 to 2.0% by weight of sodium alginate, 0.001 to 0.1% by weight of a grapefruit seed extract, 0.5 to 1.5% by weight of a natural pigment and 37.0 to 60.0% by weight of purified water to a temperature of 85 to 90° C. for 30 to 40 minutes, dropping the heated mixed solution into a 1.0 to 5.0% calcium lactate solution, and molding;
sterilizing the alginic acid beads; and
mixing the sterilized alginic acid beads with the dairy product in an amount of 1 to 10% by weight of the dairy product.
